(19) United States
(12) Patent Application Publication
(10) Pub. No.: US 2004/0177685 A1
(43) Pub. Date: Sep. 16, 2004

(54) Capacitance type humidity sensor

(75) Inventors: Hisanori Yokura, Chiryu-city (JP); Inao Toyoda, Anjo-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/791,894

(22) Filed: Mar. 4, 2004

(30) Foreign Application Priority Data
Mar. 11, 2003 (JP) 2003-65723

(51) Int. Cl. G01N 19/00

(52) U.S. Cl. 73/335.04

(57) ABSTRACT

A pair of comb-tooth-shaped electrodes are formed on the same plane of a semiconductor substrate. A protection film composed of silicon nitride film and humidity sensing film of polyimide-based polymer covers the pair of comb-tooth-shaped electrodes. A moisture-permeable film having a higher dielectric constant than the humidity sensing film and also having moisture-permeability is formed on the humidity sensing film. By this structure, the variation of the electrostatic capacitance between the pair of comb-tooth-shaped electrodes which varies in accordance with humidity variation in the humidity sensing film is increased.

### CROSS REFERENCE TO RELATED APPLICATIONS

This application is based upon, claims the benefit of priority of, and incorporates by reference the contents of Japanese Patent Application No. 2003-65723 filed on Mar. 11, 2003.

### FIELD OF THE INVENTION

The present invention relates to a capacitance type humidity sensor in which a humidity sensing film having a dielectric constant varying in accordance with humidity is interposed between a pair of electrodes and the humidity is detected on the basis of variation of the electrostatic capacitance between the pair of electrodes which is caused in accordance with variation of ambient humidity.

### BACKGROUND OF THE INVENTION

There is known a conventional capacitance type humidity sensor having a comb-tooth-shaped structure in which a pair of comb-tooth-shaped electrodes are arranged on the same plane of a substrate so as to be engaged with each other (see JP-A-2002-243690, for example). In the capacitance type humidity sensor having the comb-tooth-shaped structure as described above, humidity sensing film of polyimide-based polymer is formed so as to cover the pair of comb-tooth-shaped electrodes, thereby interposing the humidity sensing film between the pair of electrodes. Variation of the dielectric constant of the humidity sensing film in accordance with variation of the humidity is detected as a variation of the electrostatic capacitance between the pair of electrodes.

In the capacitance type humidity sensor having the comb-tooth-shaped structure as described above, when the area of the humidity sensing film is increased by increasing the number of teeth of the comb-tooth-shaped electrodes or increasing the length of the teeth of the comb-tooth-shaped electrodes, the variation of the electrostatic capacitance between the electrodes in accordance with the humidity variation in the humidity sensing film is increased, so that the sensitivity of the sensor can be enhanced. However, when the number of the teeth of the comb-tooth-shaped electrodes is increased or the length of each teeth is increased, there occurs a problem that the size of the sensor device itself is increased. Therefore, it is preferable to increase the variation of the electrostatic capacitance between the electrodes without increasing the area of the humidity sensing film.

When the thickness of the humidity sensing film is increased, the variation of the electrostatic capacitance between the electrodes can be increased. However, when the thickness of the humidity sensing film is increased beyond a certain level, the variation of the electrostatic capacitance between the electrodes does not increase even if the thickness is further increased. Therefore, there is a limit to an increase the variation of the electrostatic capacitance between the electrodes by increasing the thickness of the humidity sensing film.

### SUMMARY OF THE INVENTION

The present invention has been implemented in view of the foregoing situation, and has an object to provide a capacitance type humidity sensor that can effectively increase variation of the electrostatic capacitance between electrodes in accordance with humidity variation without increasing the area of humidity sensing film.

In order to attain the above object, a capacitance type humidity sensor according to a first aspect of the present invention includes a substrate; first and second electrodes arranged so as to be spaced from each other at a predetermined interval on the same plane of the substrate; humidity sensing film which is formed on the substrate in conformity with the area between the first and second electrodes and has a dielectric constant varying in accordance with humidity; and moisture-permeable film formed on the humidity sensing film in conformity with at least a part of the area between the first and second electrodes. The moisture-permeable film has a dielectric constant higher than that of the humidity sensing film and transmits water therethrougth.

According to the above construction, since the moisture-permeable film having a higher dielectric constant is formed on the humidity sensing film, the variation of the electrostatic capacitance between the electrodes in accordance with the humidity variation in the humidity sensing film can be more greatly increased in comparison with a case where no moisture-permeable film is formed. As described above, the variation of the electrostatic capacitance between the electrodes can be increased without increasing the area of the humidity sensing film.

According to a second aspect of the present invention, the moisture-permeable film may be formed of silicon gel. In general, the dielectric constant of the humidity sensing film is equal to 2 to 6. The silicon-based gel has a higher dielectric constant and excellent moisture-permeability. Therefore, when the moisture-permeable film is formed of silicon gel, reduction of the response characteristic of the capacitance type humidity sensor can be suppressed by forming the moisture-permeable film.

Furthermore, according to a third aspect of the present invention, a protection film may be formed so as to cover the first and second electrodes and the gap between the first and second electrodes.

According to a fourth aspect of the present invention, the protection film may be formed from film containing at least silicon nitride film or silicon oxide film. By forming the protection film containing the silicon nitride film or silicon oxide film as described above, the protection of the first and second electrodes from water is ensured, and thus the moisture resistance of first and second electrodes can be enhanced. According to a fifth aspect of the present invention, when a semiconductor substrate is used as the substrate, the first and second electrodes are preferably formed on insulating film formed on the principal surface of the semiconductor substrate. By constructing the above capacitance humidity sensor on the semiconductor substrate, a processing circuit for a detection signal output from the capacitance type humidity sensor can be formed on the same substrate. In this case, however, it is preferably to form insulating film on the principal surface of the semiconductor substrate and to form the first and second electrodes on the insulating film in order to prevent current leakage from the first and second electrodes.

According to a sixth aspect of the present invention, each of the first and second electrodes comprises a common electrode portion and plural comb-tooth-shaped electrode portions extending from the common electrode portion in one direction, and the first and second electrodes are arranged so that the comb-tooth-shaped electrode portions of the first electrode and the comb-tooth-shaped electrode portions of the second electrode are alternately arranged. As described above, the first and second electrodes are constructed as the comb-tooth-shaped electrodes and the comb-tooth-shaped electrode portions thereof are alternately arranged, whereby the confronting area between the pair of electrodes can be increased and thus the variation of the electrostatic capacitance between the electrodes in accordance with the humidity temperature in the humidity sensing film can be increased.

### BRIEF DESCRIPTION OF THE DRAWINGS

The above and other objects, features and advantages of the present invention will become more apparent from the following detailed description made with reference to the accompanying drawings. In the drawings:

FIG. 1 is a plan view of a capacitance type humidity sensor according to a preferred embodiment;

FIG. 2 is a cross-sectional view showing a capacitance type humidity sensor taken along line II-II of FIG. 1; and

FIG. 3 is a diagram showing electrostatic capacitors formed between a pair of electrodes.

### DETAILED DESCRIPTION OF THE PREFERRED EMBODIMENTS

A preferred embodiment according to the present invention will be described hereunder with reference to the accompanying drawings.

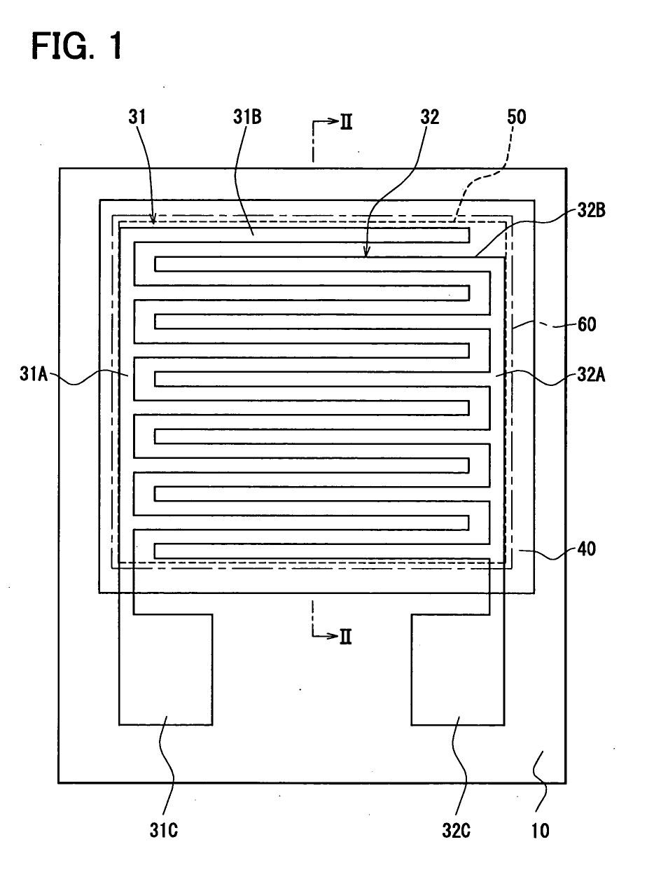

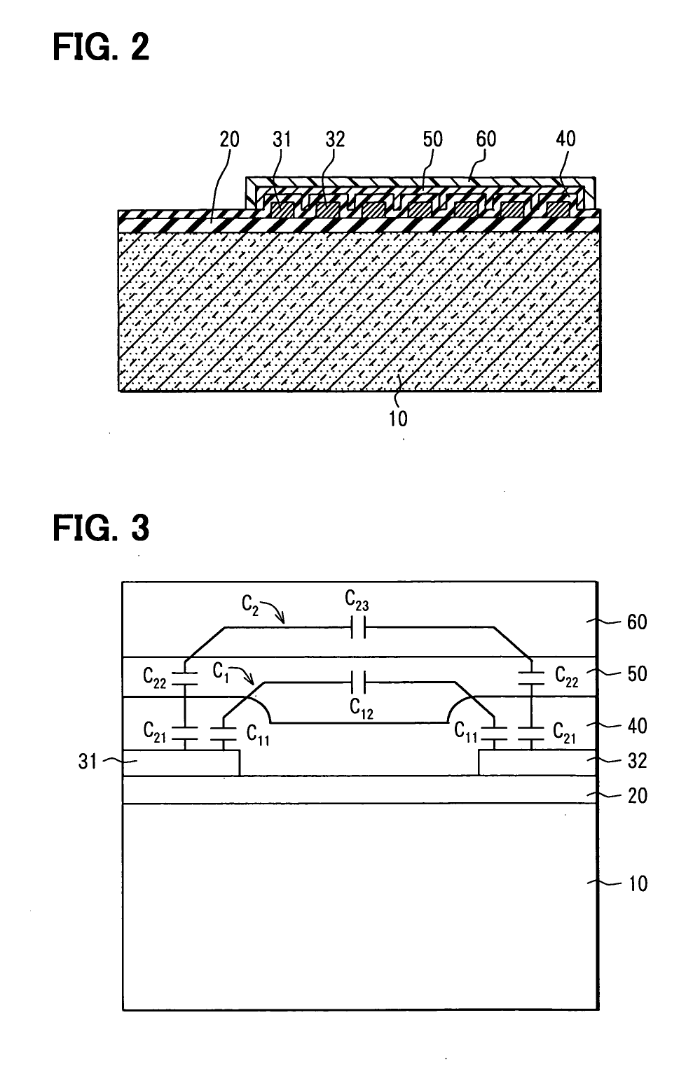

FIG. 1 is a plan view showing a capacitance type humidity sensor and FIG. 2 is a cross-sectional view taken along II-II line of FIG. 1.

In FIGS. 1 and 2, reference numeral 10 represents a semiconductor substrate, and it is formed of silicon, for example. A silicon oxide film 20 is formed as insulating film on the principal surface of the semiconductor substrate 10. A pair of electrodes 31, 32 are arranged on the same plane of the silicon oxide film 20 to confront each other.

The shape of the pair of the electrodes 31, 32 is not limited to a specific one. However, according to this embodiment, each of the electrodes 31, 32 comprises a common electrode 31A, 32A and plural comb-tooth-shaped electrode portions 31B, 32B extending from the common electrode portion 31A, 32A in one direction. The pair of electrodes 31, 32 are arranged so that the comb-tooth-shaped electrode portions 31B, 32B of the pair of electrodes 31, 32 are alternately arranged. As described above, by adopting the comb-tooth shape as the shape of the pair of electrodes 31, 32, the confronting area of the comb-tooth-shaped electrode portions 31B, 32B can be increased while reducing the arrangement area of the electrodes 31, 32. Accordingly, the variation of the electrostatic capacitance between the pair of electrodes 31, 32 in accordance with the variation of the ambient humidity can be increased, and thus the sensitivity of the sensor can be enhanced.

The pair of electrodes 31, 32 are formed by adhesively attaching metal material such as aluminum, copper, gold, platinum or the like onto the semiconductor substrate 10 by deposition, sputtering or the like, and then subjecting the metal material to patterning in a comb-tooth-shaped pattern.

Thereafter, silicon nitride film 40 as protection film is formed on the semiconductor substrate 10 so as to cover the pair of electrodes 31, 32. The silicon nitride film 40 is formed by plasma CVD method or the like so as to have the same thickness over the whole area on the semiconductor substrate 10. However, when the electrodes 31, 32 have corrosion resistance, no silicon nitride film may be formed.

As shown in FIG. 1, the pair of electrodes 31, 32 are equipped with pads 31C, 32C through which the electrodes 31, 32 are connected to a signal processing circuit for detecting the variation of the electrostatic capacitance between the pair of electrodes 31, 32, respectively. The pads 31C, 32C are required to be exposed so that they are connected to the signal processing circuit, and thus they are not covered by the silicon nitride film 40. Furthermore, according to this embodiment, the capacitance type humidity sensor is formed on the semiconductor substrate 10, and thus the signal processing circuit for detecting the variation of the capacitance type humidity sensor can be formed on the principal surface of the semiconductor substrate 10.

Furthermore, humidity sensing film 50 is formed on the silicon nitride film 40 so as to cover the pair of electrodes 31, 32 and the gap between the electrodes 31, 32. In FIG. 1, the area in which the humidity sensing film 50 is formed is represented by a dotted line.

The humidity sensing film 50 is formed of polymer organic material having moisture-absorption characteristics, and specifically it may be formed of polyimide-based polymer, cellulose acetate butyrate or the like. The formation of the humidity sensing film 50 on the silicon nitride film 40 is carried out by coating the polymer organic material having the moisture-absorption characteristics with a spin coat method, a printing method or the like.

With respect to the humidity sensing film 50, when water infiltrates into the film, the dielectric constant of the humidity sensing film 50 is varied in accordance with the amount of water thus infiltrating because the dielectric constant of water is large. As a result, the electrostatic capacitance of a capacitor constructed by the pair of electrodes 31, 32 with the humidity sensing film 50 as a part of the dielectric material. The humidity can be detected on the basis of the electrostatic capacitance between the pair of electrodes 31, 32 because the amount of water contained in the humidity sensing film 50 corresponds to the ambient humidity around the capacitance type humidity sensor.

Moisture-permeable film 60 having moisture-permeability through which water is allowed to permeate is formed so as to cover the humidity sensing film 50. In FIG. 1, the formation area of the moisture-permeable film 60 is represented by a chain line. The moisture-permeable film 60 has a higher dielectric constant than that of the humidity sensing film 50. Furthermore, in this embodiment, the dielectric constant of the humidity sensing film 50 is varied in the range from 2.9 to 3.3 as the humidity varies in the range from 0% RH to 100% RH. However, the dielectric constant of the moisture-permeable film 60 is equal to 7.0. In general, the dielectric constant of the humidity sensing film 50 is substantially equal to a value between 2.0 and 6.0. The dielectric constant of the moisture-permeable film 60 is substantially equal to a value between 4.0 and 10.0.

As described above, the variation of the electrostatic capacitance between the pair of electrodes 31, 32 in accordance with the humidity variation of the humidity sensing film 50 can be increased by forming the moisture-permeable film 60 having a higher dielectric constant than the humidity sensing film 50 on the humidity sensing film 50. Furthermore, as the dielectric constant of the moisture-permeable film 60 is higher, the variation of the electrostatic capacitance between the electrodes 31, 32 in accordance with the humidity variation is increased. This will be described more fully below with reference to FIG. 3.

It is estimated that an infinite number of first capacitors C₁, each of which comprises plural capacitors C₁₁, C₁₂ connected to one another in series through a path which does not pass through the moisture-permeable film 60, and an infinite number of second capacitors C₂, each of which comprises plural capacitors C₂₁ to C₂₃ connected to one another in series through a path passing through the moisture-permeable film 60, are formed between the electrodes 31, 32 as shown in FIG. 3. Here, the electrostatic capacitance C between the electrodes 31, 32 is represented by the electrostatic capacitance C₁ of the first capacitor and the electrostatic capacitance C₂ of the second capacitor as follows:

C=C₁+C₂ (1)

The electrostatic capacitance C₁, C₂ of the first and second capacitors are represented by the electrostatic capacitance C₁₁, C₁₂, C₂₁ to C₂₃ of the respective capacitors as follows:

1/C₁=2/C₁₁+1/C₁₂ (2)

1/C₂=2/C₂₁+2/C₂₂+1/C₂₃ (3)

Here, when the dielectric constant of the protection film 40 is represented by εₚ, the dielectric constant of the humidity sensing film 50 is represented by εᵥ and the dielectric constant of the moisture-permeable film 60 is represented by ε_{w}, each of the composite electrostatic capacitance Cp (=2/C₂₁) of the capacitor C₂₁ of the protection film portion, the composite electrostatic capacitance Cv (=2/C₂₂) of the capacitor C₂₂ of the humidity sensing portion and the electrostatic capacitance Cw (=C₂₃) of the capacitor C₂₃ of the moisture-permeable film portion which construct the second capacitor C₂ can be represented as follows:

cp=εₚxₚ (xₚ>0) (4)

cv=εᵥxᵥ (xᵥ>0) (5)

cw=ε_{w}x_{w} (x_{w}>0) )6)

Furthermore, the dielectric constant εᵥ of the humidity sensing film 50 satisfies εᵥ<ε_{w}, and thus it can be represented by using the dielectric constant ε_{w} of the moisture-permeable film as follows:

εᵥ=kε_{w} (0<k<1) (7)

The dielectric constant εₚ of the protection film 40 can be represented by using the dielectric constant ε_{w} of the moisture-permeable film as follows:

εₚ=rε_{w} (r>0) (8)

When Cf represents the composite electrostatic capacitance of the capacitors Cp, Cw of the protection film portion and the moisture-permeable film 60 portion which are invariable with humidity, the composite electrostatic capacitance Cf is represented by using the equations 4, 6 and 8 as follows.

$$C f = \frac{C p \cdot C w}{C p + C w} = \frac{r {ϵ}_{w}^{2} {x}_{p} {x}_{w}}{r {ϵ}_{w} {x}_{p} + {ϵ}_{w} {x}_{w}} = \frac{r {x}_{p} {x}_{w}}{r {x}_{p} + {x}_{w}} {ϵ}_{w} \qquad ( 9 )$$

Here, if the following equation is introduced,

$$\frac{r {x}_{p} {x}_{w}}{r {x}_{p} + {x}_{w}} = {x}_{f} ( {x}_{f} > 0 ) \qquad ( 10 )$$

the composite electrostatic capacitance Cf which is invariable with temperature is represented as follows:

Cf=ε_{w}x_{f} (11)

The electrostatic capacitance C₂ of the second capacitor is achieved by combining the composite electrostatic capacitance Cf invariable with humidity and the composite electrostatic capacitance Cv of the humidity sensing film portion variable with humidity, and thus it is represented by using the equations (5), (7) and (11) as follows:

$${C}_{2} = \frac{C v \cdot C f}{C v + C f} = \frac{r {ϵ}_{w}^{2} {x}_{v} {x}_{f}}{k {ϵ}_{w} {x}_{v} + {ϵ}_{w} {x}_{f}} = \frac{k {x}_{v} {x}_{f}}{k {x}_{v} + {x}_{f}} {ϵ}_{w} \qquad ( 12 )$$

If the dielectric constant εᵥ of the humidity sensing film 50 increases to εᵥ′ (=εᵥ+Δεᵥ) due to the humidity variation, the dielectric constant εᵥ′ after the variation can be represented as follows:

εᵥ′=k′ε_{w} (0<k<k′<1) (13)

The variation ΔC₂ of the electrostatic capacitance C₂ of the second capacitor due to the variation of the dielectric constant εᵥ of the humidity sensing film is represented by using the equation (12) as follows:

$$Δ {C}_{2} = ( \frac{{k}^{′} {x}_{v} {x}_{f}}{{k}^{′} {x}_{v} + {x}_{f}} - \frac{k {x}_{v} {x}_{f}}{k {x}_{v} + {x}_{f}} ) {ϵ}_{w} = \frac{( {k}^{′} - k ) {x}_{v} {x}_{f}^{2}}{k {k}^{′} {x}_{v}^{2} + ( k + {k}^{′} ) {x}_{v} {x}_{f} + {x}_{f}^{2}} {ϵ}_{w} \qquad ( 14 )$$

Here, since k′>0, k>0, (k′−k)<0, x_{f}>0, xᵥ>0, it is apparent that as the dielectric constant ε_{w} of the moisture-permeable film 60 is larger, the variation ΔC₂ of the electrostatic capacitance C₂ of the second capacitor due to the humidity variation of the humidity sensing film 50 is larger.

The variation ΔC of the electrostatic capacitance C between the pair of electrodes 31, 32 due to the humidity variation in the humidity sensing film 50 can be represented from the equation (1) as follows:

ΔC=ΔC₁+ΔC₂ (15)

Here, the variation ΔC₁ of the electrostatic capacitance C₁ of the first capacitor is not varied in accordance with the dielectric constant ε_{w} of the moisture-permeable film 60, and the variation ΔC₂ of the second capacitor is increased as the dielectric constant εᵥ of the moisture-permeable film 60 is larger, so that it is apparent that the variation ΔC of the electrostatic capacitance C between the pair of electrodes 31, 32 is increased as the dielectric constant ε_{w} of the moisture-permeable film 60 is larger.

When no moisture-permeable film 60 is formed like the related art, the capacitor C₂₃ is formed in the atmosphere having a low dielectric constant, and thus ε≈0. On the other hand, when the moisture-permeable film 60 having a dielectric constant ε_{w} of 4.0 to 10.0 is formed on the humidity sensing film 50 as in the case of this embodiment, it is apparent from the equation (14) that the variation ΔC of the electrostatic capacitance C between the pair of electrodes due to the humidity variation is greatly increased.

In this embodiment, the moisture-permeable film 60 is formed in conformity with the overall area between the pair of electrodes 31, 32. However, even when the moisture-permeable film 60 is formed in conformity with only a part of the area between the pair of electrodes 31, 32, the variation of the electrostatic capacitance between the electrodes 31, 32 can be increased as compared with the case in which the moisture-permeable film 60 is not formed. However, when the moisture-permeable film 60 is formed in conformity with the whole area between the pair of electrodes 31, 32 like this embodiment, the variation of the electrostatic capacitance between the electrodes 31, 32 can be increased to a maximum.

The variation of the electrostatic capacitance was measured in the range of 0% RH to 100% RH in relative humidity at a temperature of 25° C. when the moisture-permeable film 60 having the dielectric constant 7.0 was formed on the humidity sensing film 50 whose dielectric constant varied in the range from 2.9 to 3.3 with the humidity variation. As a result, the variation of the electrostatic capacitance is increased by 30% over the whole relative humidity range as compared with the case where the moisture-permeable film 60 is not formed.

The moisture-permeable film 60 is formed of material having excellent moisture-permeability such as silicon gel, fluorine gel or the like by a method using droplet or the like. When the moisture permeability of the moisture-permeable film 60 is insufficient, the response characteristic of the capacitance type humidity sensor is lowered.

Here, as another type of the conventional capacitance type humidity sensor is known a humidity sensor having such a structure that a pair of electrodes are disposed at the upper and lower sides and humidity sensing film is interposed between the pair of electrodes (referred to as a parallel flat plate structure).

For example, according to a capacitance type humidity sensor having a parallel flat plate structure described in JP-A-60-166854, a lower electrode is formed on a substrate, humidity sensing film is equipped on the lower electrode and a thin upper electrode having moisture permeability is equipped on the humidity sensing film. In the conventional capacitance type humidity sensor, the upper electrode is structurally exposed to the external environment, so that there is a problem in moisture resistance or there is a problem that a part of the humidity sensing film is scattered and contaminates the device when the upper electrode is formed by deposition or sputtering. However, the structure that the humidity sensing film is sandwiched by the electrodes more enhances the sensitivity as compared with the capacitance type humidity sensor having the comb-tooth-shaped structure.

According to the capacitance type humidity sensor of this embodiment, the sensitivity which is lower than that of the capacitance type humidity sensor having the parallel flat plate structure is enhanced with solving the problem inherent to the parallel flat plate structure (the moisture resistance of the electrodes, the contamination of the device, etc.) by adopting the comb-tooth-shaped structure. Furthermore, according to the capacitance type humidity sensor of this embodiment, any problem such as pollution of the device does not occur in the manufacturing process, and thus there is an advantage that the humidity sensor of this embodiment can be manufactured by using a normal semiconductor manufacturing line.

Therefore, the present disclosure generally concerns a capacitance type humidity sensor comprising first and second electrodes 31, 32 disposed in an alternating arrangement on a same plane of an insulating film 20 of a semiconductor substrate 10; a humidity sensing film 50 disposed above the first and second electrodes 31, 32, wherein a dielectric constant of the humidity sensing film 50 varies in accordance with a moisture content, wherein humidity is detected on the basis of an electrostatic capacitance variation between the first and second electrodes 31, 32 in accordance with the moisture content; and a moisture-permeable film 60 disposed above the humidity sensing film 50, wherein the moisture-permeable film 60 has a dielectric constant that is higher than the dielectric constant of the humidity sensing film 50 to thereby increase the electrostatic capacitance between the first and second electrodes 31, 32.

The description of the invention is merely exemplary in nature and, thus, variations that do not depart from the gist of the invention are intended to be within the scope of the invention. Such variations are not to be regarded as a departure from the spirit and scope of the invention.

What is claimed is

1. A capacitance type humidity sensor comprising:
a substrate;
first and second electrodes arranged so as to be spaced from each other at a predetermined interval on the same plane of the substrate;
humidity sensing film formed on the substrate in conformity with at least the area between the first and second electrodes and having a dielectric constant varying in accordance with humidity; and
moisture-permeable film formed on the humidity sensing film in conformity with at least a part of the area between the first and second electrodes, having a dielectric constant higher than the humidity sensing film and transmitting water therethrougth.

2. The capacitance type humidity sensor according to claim 1, wherein the moisture-permeable film is formed of silicon gel.

3. The capacitance type humidity sensor according to claim 1, wherein a protection film is formed to cover the first and second electrodes and the gap between the first and second electrodes, and the humidity sensing film is formed on the protection film.

4. The capacitance type humidity sensor according to claim 2, wherein a protection film is formed to cover the first and second electrodes and the gap between the first and second electrodes, and the humidity sensing film is formed on the protection film.

5. The capacitance type humidity sensor according to claim 4, wherein the protection film is comprised of silicon nitride film or silicon oxide film.

6. The capacitance type humidity sensor according to claim 4, wherein a semiconductor substrate is used as the substrate, and the first and second electrodes are formed on insulating film formed on a principal surface of the semiconductor substrate.

7. The capacitance type humidity sensor according to claim 1, wherein each of the first and second electrodes comprises a common electrode portion and plural comb-tooth-shaped electrode portions extending from the common electrode portion in one direction, and the first and second electrodes are arranged so that the comb -tooth-shaped electrode portions of the first electrode and the comb-tooth-shaped electrode portions of the second electrode are alternately arranged.

8. The capacitance type humidity sensor according to claim 7, wherein a semiconductor substrate is used as the substrate, and the first and second electrodes are formed on insulating film formed on a principal surface of the semiconductor substrate.

9. A capacitance type humidity sensor comprising:
first and second electrodes disposed in alternating arrangement on a same plane of an insulating film of a semiconductor substrate;
a humidity sensing film disposed above the first and second electrodes, wherein a dielectric constant of the humidity sensing film varies in accordance with a moisture content, wherein humidity is detected on the basis of an electrostatic capacitance variation between the first and second electrodes in accordance with the moisture content; and
a moisture-permeable film disposed above the humidity sensing film, wherein the moisture-permeable film has a dielectric constant that is higher than the dielectric constant of the humidity sensing film to thereby increase the electrostatic capacitance between the first and second electrodes.
